(19) United States
(12) Patent Application Publication
(10) Pub. No.: US 2019/0303176 A1
(43) Pub. Date: Oct. 3, 2019

(54) Using Machine Learning to Optimize Memory Usage

(71) Applicant: QUALCOMM Incorporated, San Diego, CA (US)

(72) Inventor: Dheebu Kaithavana JOHN, Hyderabad (IN)

(21) Appl. No.: 15/940,728

(22) Filed: Mar. 29, 2018

(51) Int. Cl. G06F 9/445; G06N 3/08; G06N 3/04; G06N 5/04; G06N 99/00; G06F 11/30

(52) U.S. Cl. CPC G06F 9/44578; G06N 3/08; G06F 11/3037; G06N 5/046; G06N 99/005; G06N 3/04

(57) ABSTRACT

Disclosed are methods and apparatuses for optimizing a usage of a memory storing apps. In an aspect, an apparatus receives time data reflecting when each of the apps in the memory was used, receives location data reflecting where each of the apps in the memory was used, receives frequency data reflecting a usage frequency of each of the apps in the memory and trains a neural network to learn an app usage pattern based on the received time data, received location data and received frequency data.

### FIELD

The present disclosure relates generally to mobile devices, and more particularly, to using machine learning to optimize memory usage.

### BACKGROUND

Mobile devices have become integral part of the modern life. People use mobile devices to communicate and schedule their daily lives. Many of the mobile devices are smart phones that allows the users to use many different types of apps that help the users in their daily lives. However, having many open apps on a mobile device strains the memory resource of the mobile device. Often times, a mobile device may close out certain apps because the mobile device may suffer from memory shortage whereas certain unwanted apps may continue to drain the memory resource.

### SUMMARY

The following presents a simplified summary of one or more aspects to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment or a mobile device including at least one processor and a memory coupled to the at least one processor. The processor receives time data reflecting when each of the apps in the memory was used, receives location data reflecting where each of the apps in the memory was used, receives frequency data reflecting a usage frequency of each of the apps in the memory, and trains a neural network to learn app usage pattern based on the received time data, received location data and received frequency data.

In an aspect, a method of optimizing a usage of a memory storing apps in a mobile device includes receiving time data reflecting when each of the apps in the memory was used, receiving location data reflecting where each of the apps in the memory was used, receiving frequency data reflecting a usage frequency of each of the apps in the memory, and training a neural network to learn app usage pattern based on the received time data, received location data and received frequency data.

In an aspect, an apparatus for optimizing a usage of a memory storing apps in a mobile device includes means for receiving time data reflecting when each of the apps in the memory was used, means for receiving location data reflecting where each of the apps in the memory was used, means for receiving frequency data reflecting a usage frequency of each of the apps in the memory, and means for training a neural network to learn app usage pattern based on the received time data, received location data and received frequency data.

In an aspect, a non-transitory computer-readable medium storing computer-executable instructions for automatically setting a reminder includes computer-readable instructions comprising at least one instruction to receive time data reflecting when each of the apps in the memory was used, receive location data reflecting where each of the apps in the memory was used, receive frequency data reflecting a usage frequency of each of the apps in the memory, and train a neural network to learn app usage pattern based on the received time data, received location data and received frequency data

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communication system and an access network.

FIG. 2 illustrates a deep convolutional network and its inputs according to an aspect.

FIG. 3 illustrates a flowchart of a method of optimizing a usage of a memory storing apps in a mobile device diagram illustrating a neural network in accordance with aspects of the present disclosure.

FIG. 4 illustrates an example implementation of designing a neural network using a system-on-chip (SOC), including a general purpose processor in accordance with an aspect.

FIG. 5 is a diagram illustrating a neural network in accordance with aspects of the present disclosure.

FIG. 6 illustrates an exemplary mobile device that may be suitably used in accordance with various aspects described herein.

FIG. 7 is a simplified block diagram of various aspects of an apparatus configured to support the functionalities disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of mobile devices will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

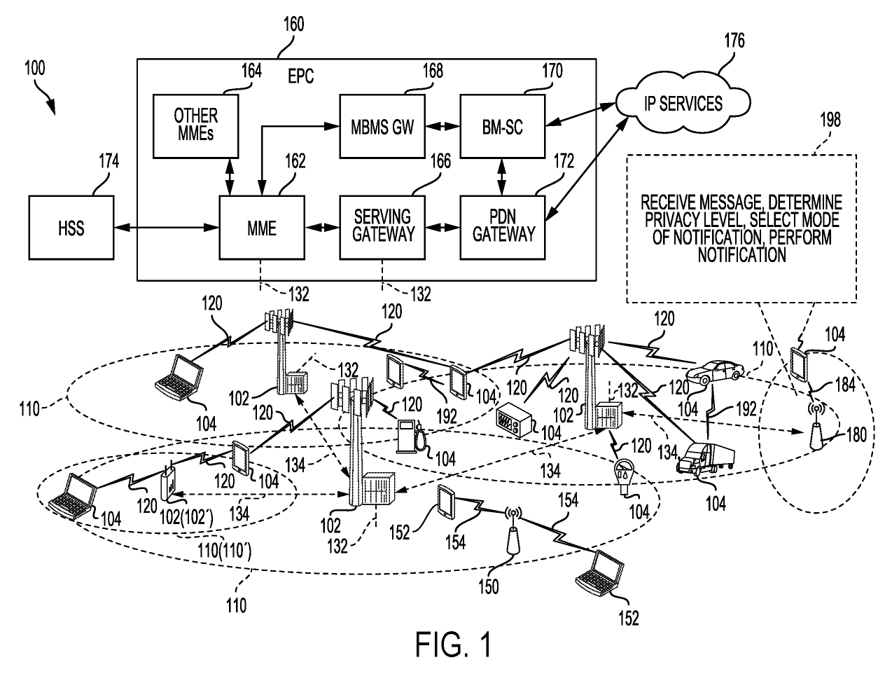

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104/base station 180 may be configured to receive a message, determine a privacy level of the message, select a mode of notification of the message based on the determined privacy level of the message, and perform a notification action based on the selected mode of notification (198).

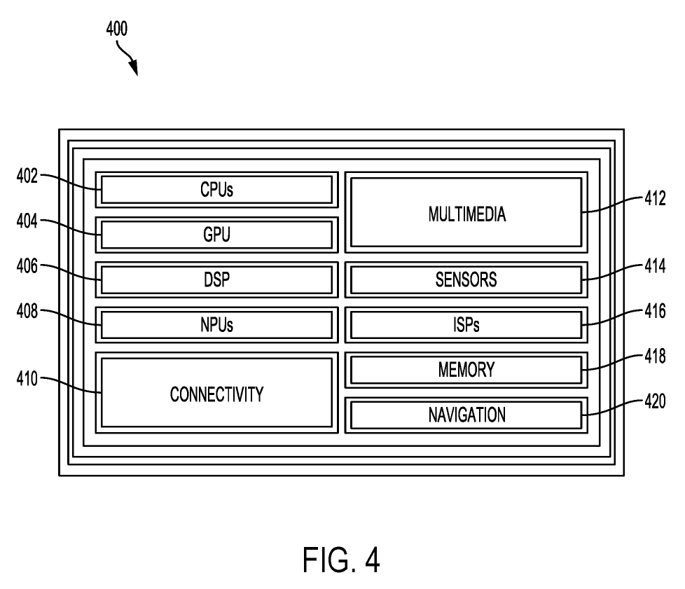

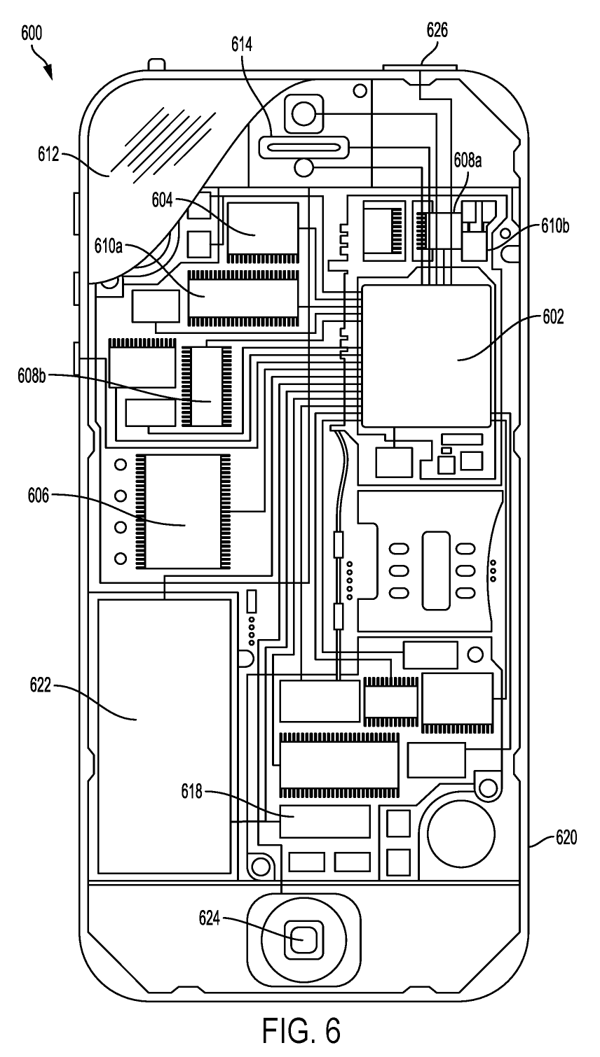

According to various aspects, FIG. 6 illustrates an exemplary mobile device or UE 600 suitable for use in accordance with the various aspects and embodiments described herein. The mobile device 600 may be one of the UEs 104 shown in FIG. 1. For example, in various embodiments, the mobile device 600 may include a processor 602 coupled to a touchscreen controller 604 and an internal memory 606. The processor 602 may be one or more multi-core integrated circuits designated for general or specific processing tasks. The processor 602 maybe a system-on-chip (SOC), which may include a general-purpose processor (CPU) or multi-core general-purpose processors (CPUs). The processor 602 may be a system-on-a-chip (SOC) 400 shown in FIG. 4, which may include a general-purpose processor (CPU) or multi-core general-purpose processors (CPUs) 402 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 408, in a memory block associated with a CPU 402, in a memory block associated with a graphics processing unit (GPU) 404, in a memory block associated with a digital signal processor (DSP) 406, in a dedicated memory block 418, or may be distributed across multiple blocks. Instructions executed at the general-purpose processor 402 may be loaded from a program memory associated with the CPU 402 or may be loaded from a dedicated memory block 418.

The SOC 400 may also include additional processing blocks tailored to specific functions, such as a GPU 404, a DSP 406, a connectivity block 410, which may include fourth generation long term evolution (4G LTE) connectivity, unlicensed Wi-Fi connectivity, USB connectivity, Bluetooth connectivity, and the like, and a multimedia processor 412 that may, for example, detect and recognize gestures. In one implementation, the NPU is implemented in the CPU, DSP, and/or GPU. The SOC 400 may also include a sensor processor 414, image signal processors (ISPs) 416, and navigation processor 420, which may include a global positioning system.

The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, a display of the mobile device need not have touchscreen capabilities.

The mobile device 600 may have one or more cellular network transceivers 608a, 608b coupled to the processor 602 and configured to send and receive cellular communications over one or more wireless networks. The transceivers 608a and 608b may be used with the above-mentioned circuitry to implement the various aspects and embodiment described herein.

In various embodiments, the mobile device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not explicitly shown in FIG. 6).

In various embodiments, the mobile device 600 may also include one or more speakers 614 to provide audio outputs. The mobile device 600 may also include a housing 620, which may be constructed of a plastic, metal, or a combination of materials, to contain all or one or more of the components discussed herein. The mobile device 600 may include a power source 622 coupled to the processor 602, such as a disposable or rechargeable battery. The rechargeable battery 622 may also be coupled to the peripheral device connection port (not shown) to receive a charging current from a source external to the mobile device 600. The mobile device 600 may also include a physical button 624 configured to receive user inputs and a power button 626 configured to turn the mobile device 600 on and off.

Aspects of the present disclosure are not limited to the general-purpose processor 402 performing the aforementioned functions. The code may also be executed by the CPU, DSP, GPU, and/or any other type of processor.

In an aspect, a neural network implemented by the SOC 400 may be a deep convolutional network. A deep convolutional network is particularly well suited for learning the behavior of the user of the mobile device 600, including the app usage pattern on the mobile device 600. Based on the learned app usage pattern of the user, the neural network may monitor the app usage of the user to optimize the memory usage of the mobile device 600. However, the SOC 400 is not limited to a deep convolutional network but may implement other types of neural network such as a recurrent neural network or spiking neural network. A recurrent neural network is also well suited for learning behaviors and the app usage pattern of the user of the mobile device 600.

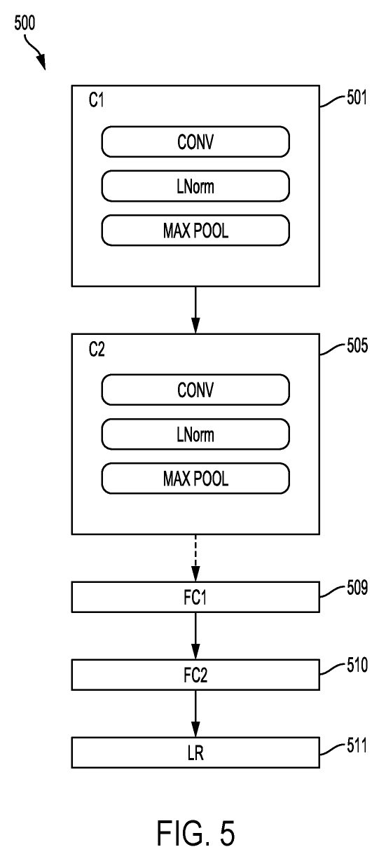

FIG. 5 is a block diagram illustrating an exemplary deep convolutional network (DCN) 500 that may be implemented in the processor 602. The deep convolutional network 500 may include multiple different types of layers based on connectivity and weight sharing. As shown in FIG. 5, the exemplary deep convolutional network 500 includes multiple convolution blocks 501 and 505 (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 500 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of the deep convolutional network 500 may be loaded on a CPU 402 or GPU 404 of the SOC 400, optionally based on an ARM instruction set, to achieve high performance and low power consumption. In alternative embodiments, the parallel filter banks may be loaded on the DSP 406 or an ISP 416 of the SOC 400. In addition, the DCN 500 may access other processing blocks that may be present on the SOC 400, such as processing blocks dedicated to sensors 414 and navigation 420. In an aspect, the DCN 500 may be implemented in the NPU 408.

The deep convolutional network 500 may also include one or more fully connected layers 509 and 510 (e.g., FC1 and FC2). The deep convolutional network 500 may further include a logistic regression (LR) layer 511. The deep convolutional network 500 may also use batch normalization layers, shortcuts between layers, and splits in a network graph. Between each layer of the deep convolutional network 500 are weights (not shown) that are to be updated. The output of each layer may serve as an input of a succeeding layer in the deep convolutional network 500 to learn hierarchical feature representations from input data (e.g., images, audio, video, sensor data and/or other input data) supplied at the first convolution block 501.

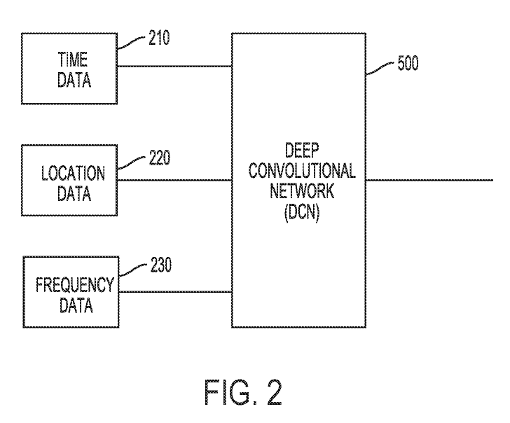

In an aspect, the DCN 500 learns the app usage pattern of the user of the mobile device 600. First, the DCN 500 learns when the apps are used during the day. In other words, the DCN 500 learns when each of the apps are opened, used and closed. The DCN 500 receives as an input the precise times when each of the apps was opened, used and closed by the user of the mobile device 600. As shown in FIG. 2, the DCN 500 receives and collects the time data 210 as an input to learn the app usage pattern of the user. In an aspect, the DCN 500 may receive the data from different processing blocks in the SOC 400 such as CPUs 402, DSP 406, navigation 420, and/or any other processing units that are necessary to provide the data needed to train the DCN 500. For example, a taxi calling app such as Uber may be used in the morning at 8:00 AM and in the evening at 6:00 PM. The taxi calling app may stay opened during the day but not used during the day until in the evening when a taxi is needed. The taxi calling app may be closed after a taxi is called and not opened again until the next morning. However, this pattern of the taxi calling app may change during the weekends. During the weekends, the user of the app may use the app in the afternoon at 2:00 PM instead of 8:00 AM. Thus, on Saturdays, the user may open the taxi calling app at 2:00 PM instead of 8:00 AM. The DCN 500 collects such data as its input to learn the app usage pattern of the user of the mobile device 600. The DCN collects the time of the day usage of each of the apps to learn the app usage pattern of the user.

In addition to the time of the day usage of each of the apps, the DCN 500 receives and collects data regarding the location of the mobile device 600 when each of the apps was opened, used and closed. As shown in FIG. 2, the DCN 500 receives and collects the location data 220. The DCN 500 may work with the navigation processor 420 to collect the location data regarding each of the apps so that the DCN 500 learns the app usage pattern of the user of the mobile device 600. However, in an aspect, the DCN 500 is not limited to working with the navigation processor 420 but may work with other processing blocks in the SOC 400 such as CPUs 402 and DSP 406. For example, the user may use office productivity apps while the user is working in the office but use social apps and entertainment apps while the user is at home. The DCN 500 receives and collects the location data 220 from the navigation processor 420 for each of the apps installed on the mobile device 600.

Furthermore, the DCN 500 receives and collects data regarding the frequency of the usage of each of the apps installed on the mobile device 600. In other words, the DCN 500 collects the frequency data 230 that shows how frequently each of the apps is used during the day. In an aspect, the DCN 500 may receive the frequency data 230 from different processing blocks in the SOC 400 such as CPUs 402, DSP 406, navigation 420, and/or any other processing units that are necessary to provide the frequency data 230 needed to train the DCN 500. For example, the user of the mobile device 600 may use a popular messaging app five times a day whereas the user may use a calculator app once a week. As shown in FIG. 2, the DCN 500 receives and collects the frequency data 230 in addition to the time data 210 and location data 220.

The DCN 500 uses the collected data to train itself to learn and predict the app usage pattern of the user of the mobile device 600. Thus, the DCN 500 constantly monitors the app usage pattern of the user by collecting the time data 210, location data 220 and frequency data 230 and trains itself based the collected data to learn and predict the app usage pattern of the user.

After the DCN 500 trains itself on the collected data, the DCN 500 monitors the list of active apps in the memory such as the memory 606. The DCN 500 monitors which of the active apps in the memory are being used or not used and the amount of memory space taken by each of the apps in the memory 606. Based on the learned app usage pattern, the DCN 500 decides whether to keep or terminate each of the apps in the list. In other words, the DCN 500 goes through the list of active apps and decides whether to keep or terminate each of the active apps in the memory 606 based on the learned app usage pattern, the current time and the location data For example, if one of the active apps in the memory is a taxi calling app and the current time is 1:00 PM on Sunday at the user's home when the taxi calling app has never been used before on Sunday, the DCN 500 will probably direct the processor 602 to terminate the taxi calling app based on the learned app usage pattern. However, if the user is located at a restaurant on Sunday at 1:00 PM, the DCN 500 may not terminate the taxi calling app based on the learned app usage pattern since the user may use the taxi calling app to call a taxi to go to the user's home from the restaurant. The DCN 500 constantly monitors the list of the active apps in the memory to decide whether to keep or terminate each of the apps based on the learned app usage pattern. By terminating unnecessary apps from the memory 606, the mobile device 600 preserves memory space for necessary apps to be retained in the memory 606.

Furthermore, in an aspect, the DCN 500 may preload an app based on the learned app usage pattern. For example, if the user of the mobile device 600 uses a taxi calling app on Monday mornings, the DCN 500 may preload the taxi calling app automatically on Monday mornings based on the learned app usage pattern if the taxi calling app has not already been loaded into the memory 606. In another example, if the user uses a texting app throughout the day, the DCN 500 may preload the texting app in the morning automatically if the texting app has not already been loaded.

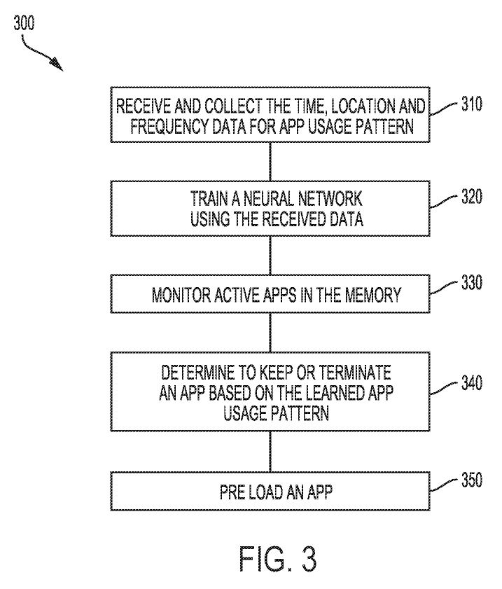

FIG. 3 is a flowchart 300 of a method of using machine learning to optimize memory usage in a mobile device. The method may be performed by a processor such as the processor 602. In one configuration, the flowchart 300 described in FIG. 3 may be performed by the mobile device 600 described above with reference to FIG. 6.

In an aspect, at 310, the DCN 500 receives time, location and frequency data to train itself on the app usage pattern of the user of the mobile device 600. In an aspect, the DCN 500 may receive the data from different processing blocks in the SOC 400 such as CPUs 402, DSP 406, navigation 420, and/or any other processing units that are necessary to provide the data needed to train the DCN 500. As discussed above, the DCN 500 receives as an input the precise times when each of the apps was opened, used and closed by the user of the mobile device 600. Furthermore, the DCN 500 receives and collects data regarding the location of the mobile device 600 when each of the apps was opened, used and closed. Finally, the DCN 500 receives and collects data regarding the frequency of usage of each of the apps installed on the mobile device 600.

At 320, the DCN 500 uses the received data to train itself to learn the app usage pattern of the user of the mobile device 600. In an aspect, the DCN 500 constantly trains itself on new data the DCN 500 receives from other processing blocks in the SOC 400. In another aspect, the DCN 500 may limit the amount of training and may stop the training after certain point.

In an aspect, at 330, the DCN 500 monitors the list of active apps in the memory. In other words, the DCN 500 monitors which of the active apps in the memory are being used or not used and the amount of memory space taken by each of the apps in the memory.

In an aspect, at 340, the DCN 500 decides whether to keep or terminate each of the apps in the list based on the learned app usage pattern, the current time and the current location data. In an aspect, the DCN 500 constantly monitors the list of the active apps in the memory to decide whether to keep or terminate each of the apps based on the learned app usage pattern. In another aspect, the DCN 500 may monitor the list of active apps at every predetermined time period. By terminating unnecessary apps from the memory 606, the mobile device 600 preserves memory space for necessary apps to be retained in the memory 606.

In an aspect, at 350, the DCN 350 may preload an app based on the learned app usage pattern, the current time and the current location data.

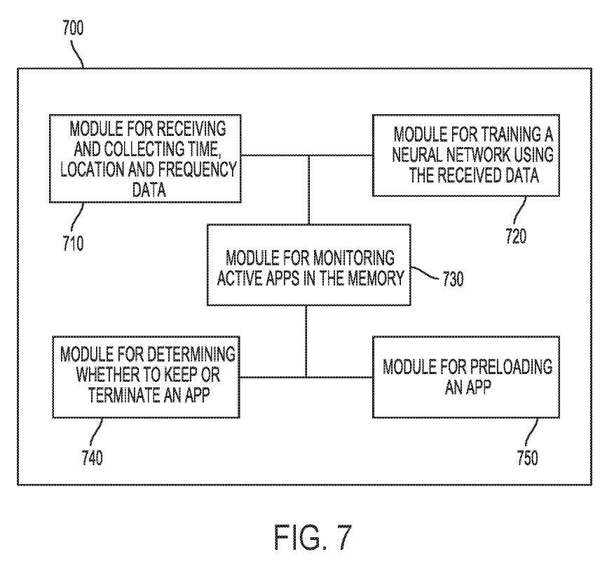

FIG. 7 illustrates an example mobile device apparatus 700 (which may correspond to the mobile device 600) represented as a series of interrelated functional modules. A module for receiving and collecting time, location and frequency data 710 may correspond at least in some aspects to, for example, a processing system, such as the processor 602, in conjunction with a storage device, such as the memory 606, as discussed herein. A module for training a neural network using the received data 720 may correspond at least in some aspects to, for example, a processing system, such as processor 602 or specifically the NPU 408, in conjunction with a storage device, such as memory 606, as discussed herein. A module for monitoring active apps in the memory 730 may correspond at least in some aspects to, for example, a processing system, such as the processor 602, in conjunction with a storage device, such as the memory 606. A module for determining whether to keep or terminate an app 740 may correspond at least in some aspects to, for example, a processing system, such as the processor 602, in conjunction with a storage device, such as the memory 606, as discussed herein. A module for preloading an app 750 may correspond at least in some aspects to, for example, a processing system, such as the processor 602, in conjunction with a storage device, such as the memory 606, as discussed herein.

The functionality of the modules 710-750 of FIG. 7 may be implemented in various ways consistent with the teachings herein. In some designs, the functionality of these modules may be implemented as one or more electrical components. In some designs, the functionality of these modules may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 7, as well as other components and functions described herein, may be implemented using any suitable means. Such means also may be implemented, at least in part, using corresponding structure as taught herein. For example, the components described above in conjunction with the “module for” components of FIG. 7 also may correspond to similarly designated “means for” functionality. Thus, in some aspects one or more of such means may be implemented using one or more of processor components, integrated circuits, or other suitable structure as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a computer-readable medium embodying a method for automatically setting a reminder of the mobile device 600.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of optimizing a usage of a memory storing apps in a mobile device, comprising:
receiving time data reflecting when each of the apps in the memory was used;
receiving location data reflecting where each of the apps in the memory was used;
receiving frequency data reflecting a usage frequency of each of the apps in the memory; and
training a neural network to learn an app usage pattern based on the received time data, received location data and received frequency data.

2. The method of claim 1, further comprising:
monitoring active apps in the memory.

3. The method of claim 2, further comprising:
determining whether to keep or terminate each of the active apps in the memory based on the learned app usage pattern.

4. The method of claim 3, further comprising:
preloading an app based on the learned app usage pattern.

5. The method of claim 1, wherein the neural network is a deep convolutional network.

6. The method of claim 1, wherein processing blocks in the mobile device collects
the received time data, received location data and received frequency data.

7. An apparatus for optimizing a usage of a memory storing apps, comprising:
means for receiving time data reflecting when each of the apps in the memory was used;
means for receiving location data reflecting where each of the apps in the memory was used;
means for receiving frequency data reflecting a usage frequency of each of the apps in the memory; and
means for training a neural network to learn an app usage pattern based on the received time data, received location data and received frequency data.

8. The apparatus of claim 7, further comprising:
means for monitoring active apps in the memory.

9. The apparatus of claim 8, further comprising:
means for determining whether to keep or terminate each of the active apps in the memory based on the learned app usage pattern.

10. The apparatus of claim 9, further comprising:
means for preloading an app based on the learned app usage pattern.

11. The apparatus of claim 7, wherein the neural network is a deep convolutional network.

12. The apparatus of claim 7, wherein processing blocks in the apparatus collects the received time data, received location data and received frequency data.

13. An apparatus for optimizing a usage of a memory storing apps, comprising:
the memory: and
at least one processor coupled to the memory and configured to:
receive time data reflecting when each of the apps in the memory was used;
receive location data reflecting where each of the apps in the memory was used;
receive frequency data reflecting a usage frequency of each of the apps in the memory; and
train a neural network to learn an app usage pattern based on the received time data, received location data and received frequency data.

14. The apparatus of claim 13, wherein the at least one processor is further configured to:
monitor active apps in the memory.

15. The apparatus of claim 14, wherein the at least one processor is further configured to:
determine whether to keep or terminate each of the active apps in the memory based on the learned app usage pattern.

16. The apparatus of claim 15, wherein the at least one processor is further configured to:
preload an app based on the learned app usage pattern.

17. The apparatus of claim 13, wherein the neural network is a deep convolutional network.

18. The apparatus of claim 13, wherein processing blocks in the apparatus collects the received time data, received location data and received frequency data.

19. A computer-readable medium storing computer executable code for optimizing a usage of a memory storing apps, comprising code to:
receive time data reflecting when each of the apps in the memory was used;
receive location data reflecting where each of the apps in the memory was used;
receive frequency data reflecting a usage frequency of each of the apps in the memory; and
train a neural network to learn an app usage pattern based on the received time data, received location data and received frequency data.

20. The computer-readable medium of claim 19, further comprising code to:
monitor active apps in the memory.

21. The computer-readable medium of claim 20, further comprising code to:
determine whether to keep or terminate each of the active apps in the memory based on the learned app usage pattern.

22. The computer-readable medium of claim 21, further comprising code to:
preload an app based on the learned app usage pattern.
